(19) United States
(12) Patent Application Publication
(10) Pub. No.: US 2005/0071176 A1
(43) Pub. Date: Mar. 31, 2005

(54) Solicitation plans

(76) Inventors: Tom J. Foegen, Rochester, MN (US); Keith F. Davis, Rochester, MN (US)

Correspondence Address: Merchant & Gould P.C., P.O. Box 2903, Minneapolis, MN, 55402-0903, US

(21) Appl. No.: 10/672,310

(22) Filed: Sep. 25, 2003

(51) Int. Cl. G06F 17/60

(52) U.S. Cl. 705/1

(57) ABSTRACT

A system and methods for the creation and management of solicitation plans, such as subscription offers, including a “pre-plan” component, an order component, and optionally a consumer response component.

### COPYRIGHT NOTICE

A portion of the disclosure of this patent document contains material subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND

The present disclosure relates to mass merchandising of print media and to systems and methods for the creation and management of solicitation plans.

Print media, such as newspapers, magazines, newsletters, technical publications, periodicals, and like media, has long relied upon companion printed pieces, such as insert cards, for placing subscription advertising, subscription offers, or renewal offers along with or within the printed media itself. Companion printed pieces can range from simple advertising inserts to sophisticated bind-ins or tear-away coversheets, and can include a multitude of offers or offerings, such as new subscription offers, renewal subscription offers, bundled subscription offers, and premium offers to entice the consumer or subscriber. The offers can have a broad range of options, such as prices, duration, discounts, and like. However, as the volume and complexity of the offers have increased there has also been a concomitant increase in, for example, the information content, record keeping, response rates, response timeliness, fulfillment logistics, marketing plans for future offerings, and like considerations associated with the use of such offers.

Traditionally, the planning phase or plan development for initial or future subscription offers and the printed pieces bearing the subscription offers was accomplished manually or in a disintegrated fashion. The above mentioned increased volume and complexity of offers has caused the planning phase to become increasingly information and labor intensive, for example, for data entry, data manipulation and database maintenance, increasingly costly, and increasingly difficult to competently manage. Despite these problems significant market opportunities for print media merchandising remain for companion printed pieces as promotional vehicles, for example, to promote subscription offers.

Thus, there is a need for an integrated planning system and method for use in merchandizing with companion printed pieces and which system and method overcome problems of planning, creation, production, response management, and like problems associated with the use of these promotional materials.

### SUMMARY

In general terms, the present disclosure relates to a computing system for managing information between a server computing environment and a remote computing platform. The server computing environment provides the remote computing platform with access to an order user interface. The remote computing platform is configured to allow a client-user to automatically access the order user interface to create and manage orders and create and manage the information contained in the orders. The remote computing platform is also configured to allow a client-user to automatically access the order user interface to create and manage solicitation plans as part of an integrated planning and ordering process.

In one aspect, the computing system comprises a server application and a server database resident on the server computing environment and a first client application resident on the remote computing platform. The server application is configured to manage and arrange information relevant to a user stored in the server database and is capable of communicating with and distributing information to the remote computing platform. The client application resident on the remote computing platform is configured to create an association between a client's desired order and the order options available from the server database. The client application is further configured to display each of the order options stored on the application database such that the user can automatically access the information transferred from the server database using the association created by the client application. The client application is further configured to display solicitation plan information with each of the order options stored on the application database such that the user can automatically access the information transferred from the server database using the association created by the client application.

In one aspect, the information on the server database includes information relevant to the user and information previously generated by the user. The information distributed from the server database to the remote computing platform can include one or more previous orders and content information corresponding to each of the previous orders.

In another aspect, a new order form or previous order can be transferred from the server database to a spreadsheet or database resident on the remote computing platform and the content information corresponding to a previous order is transferred to a spreadsheet or a database resident on the remote computing platform.

The user can automatically access the content information corresponding to a selected order using the association created by the client application. For example, the content information can be requested and retrieved directly to the client application when the user requests access to the content information, such as print order information, using the association created by the client application. Alternatively, the client application can be configured to launch a second client application to provide access to the content information, such as solicitation plan information, when the user requests access to the information using the association created by the client application.

The present disclosure also relates to a computing system for managing solicitation plans between a server computing environment and a remote computing platform. A server application is resident on the server computing environment and is configured to manage and arrange information relevant to a user stored in a server database. The server application communicates with the remote computing platform and is configured to distribute the information from the server database to the remote computing platform. The server application is further configured to process a solicitation plan, for example as part a print order, stored in an application database resident on the remote computing platform. A client application is resident on the remote computing platform and is configured to create an association between the information distributed from the server database and one or more corresponding solicitation plans stored on the application database. The client application is configured to display each of the solicitation plans stored on the application database such that the user can automatically access the information distributed from the server database using the association created by the client application.

In yet another aspect of the present disclosure, a method for managing information between a server computing environment and a remote computing platform is disclosed. In this aspect, the server computing environment includes a server application configured to manage and arrange information relevant to a user stored in a server database resident on the server computing platform.

In still yet another aspect, the present disclosure relates to a computer-readable medium having computer-executable instructions for performing a method for managing information between a server computing environment and a remote computing platform.

In still yet another aspect, the present disclosure relates to a propagated signal on a carrier detectable by a computing system and encoding a computer program of instructions for executing a computer process for managing information between a server computing environment and a remote computing platform.

In still yet another aspect, the present disclosure relates to a “pre-plan” system and “pre-plan” method, which facilitate the generation, modification, and production of promotional plans and the printed offers contained in the plans. The system and method can also facilitate management of the responses to the printed offers. The response information can be fed-back into the system and used to modify existing or on-going promotional plans or to formulate new promotional plans. The “pre-plan” system and methods of the invention in combination with networked print ordering systems can increase the transactional efficiencies of using companion printed pieces or printed articles as promotional materials, such as for print media subscription solicitations, on a large scale.

In embodiments the present disclosure provides a method for pre-planning printed products between a print vendor's server and a client's computer networked to the print vendor's server, the client's computer being adapted to display a pre-plan user-interface and a print-order user-interface which reside on the print vendor's server, the method comprising:

generating a first plan with the pre-plan user-interface on the client's computer;

exporting the resulting first plan from the client's computer to individuals within the client's organization;

receiving first input on the client's computer from the individuals having received and reviewed the resulting exported first plan; and

optionally revising on the client's computer the first plan based upon the received first input;

creating a first print-order on the client's computer, by:
a) importing the resulting plan into the print-order user-interface; and
b) selecting graphic elements for the print order; and

submitting the resulting first print-order to the print vendor for production via the print vendor's server.

In embodiments the present disclosure provides a pre-plan system for managing printed information of printed products between a print vendor's server and a client's computer networked to the print vendor's server, the client's computer being adapted to display a user-interface which interface resides on the print vendor's server, the system comprising:

1) a print-order component operative to:
a) create;
b) optionally revise; and
c) submit,
   a print-order by the client to the print vendor for printing, the print-order component having a layout information user-interface and plan-offer information user-interface; and

2) an export-import component operative to:
a) export a first plan-offer from the plan-offer information user-interface to individuals within the client's organization;
b) receive input from the individuals having received and responded to the exported first plan-offer;
c) optionally revise the first plan-offer in view of the received input; and
d) import the resulting plan-offer into the print-order component to complete the print order prior to submitting for printing.

In embodiments the present disclosure provides a pre-planning system for managing and marketing printed products, between a print vendor's server and a client's computer networked to the print vendor's server, the client's computer being adapted to display a user-interface over the print vendor's server, the system comprising:

means for creating and submitting a first print-order by the client, the print-order including a layout component and an plan component;

means for exporting the plan component of the first print-order to individuals within the client's organization;

means for receiving input from individuals having received the exported plan component;

means for optionally revising the plan component based on the received input; and

means for importing the un-revised first plan component or else the optionally revised second plan component into the first print-order to complete the order for production.

In embodiments, the present disclosure provides a method for pre-planning printed products on a remote computing platform networked to a server computing environment, the remote computing platform being adapted to display a pre-plan user-interface and a print-order user-interface available from the server computing environment, the method comprising:

generating a first plan on the pre-plan user-interface;

exporting the resulting first plan within the remote computing platform's organization;

receiving first input on the resulting exported first plan from within the organization on the remote computing platform;

optionally revising the first plan to provide a revised second plan based upon the received first input on the remote computing platform;

creating a first print-order on the print-order user interface by:
a) importing the resulting first plan or the optionally revised second plan; and
b) selecting graphic elements for the print order;
   and

submitting the resulting first print order to the server computing environment.

In embodiments, the present disclosure provides in a computer system having a graphical user interface including a display and a selection device, a method of managing plan-order information, the method comprising:

retrieving, on a first client computer, a set of menu items from the pre-plan component of a print-order user-interface on a print vendor's host computer, each of the menu items representing a subscription offer creation option;

displaying the set of menu items on the first client computer;

receiving a menu entry selection signal indicative of the selection device pointing at a selected menu item from the set of menu items;

in response to the signal, exporting the selected menu items to a second client instrument;

receiving signals indicative of changes to the exported selected menu items on the first client computer from the second client instrument;

optionally modifying the selected menu items with received changes;

importing the resulting selected menu items or optionally modified selected menu items into a print vendor's server to complete the plan-offer component of a print-order for printing; and

storing the imported menu items on the print vendor's server for subsequent printing.

In embodiments, the present disclosure provides in computer-readable medium having computer-executable instructions for performing a method comprising:

populating a database with values which specify a represented first print-order, the print-order including a layout component and a plan-offer component displayed on a networked computer user-interface;

exporting the plan-offer component of the populated database to a device within an organization;

receiving input concerning the exported plan-offer component from the device within the organization;

optionally revising the plan-offer component based on the received input to provide a revised second plan-offer component;

importing the un-revised plan-offer component or the optionally revised second plan-offer component into the user-interface to complete the first print-order for print production; and

optionally, following printing and distribution of the printed pieces defined by the first print-order to customers:

electronically receiving customer responses to the offer contained in the printed plan-offer component; and

revising the plan-offer component in view of the received customer responses.

In embodiments, the present disclosure provides a set of application program interfaces embodied on a computer-readable medium for execution on a computer in conjunction with an application program that specifies a client's print-order to a print vendor, comprising:

a first interface that receives a client's plan-offer information;

a second interface that receives a client's print layout information;

a third interface that combines the plan-offer information and print layout information into a print-order and electronically transmits the print-order to a print vendor for printing the print-order; and

optionally a fourth interface adapted to receive input based on offer responses from consumer recipients of the resulting printed print-order and adapted to provide input to the first interface.

These and other embodiments are illustrated herein.

### BRIEF DESCRIPTION OF THE DRAWINGS

FIG. 1 illustrates a summary flow chart for “pre-plan” creation, “pre-plan” review and revision, and print order creation and submission incorporating the “pre-plan,” in embodiments of the present disclosure.

FIG. 2 illustrates a flow chart for creation of the “pre-plan” or plan-offer component in embodiments of the present disclosure.

FIG. 3 illustrates a flow chart for review and revision of the “pre-plan” component in embodiments of the present disclosure.

FIG. 4 illustrates a flow chart for creation of the print order component in embodiments of the present disclosure.

FIG. 5 illustrates a functional block diagram of the system and method in embodiments of the present disclosure.

FIG. 6 illustrates a “pre-plan” creation screen in embodiments of the present disclosure.

FIG. 7 illustrates a print-order component creation screen in embodiments of the present disclosure.

FIG. 8A and B illustrate other print-order component creation screens in embodiments of the present disclosure.

### DETAILED DESCRIPTION

In embodiments the present disclosure provides a method for pre-planning printed products, which products can include, for example, offer information, subscriber response information, or both, between a print vendor's server and a client's computer networked to the print vendor's server, the client's computer being adapted to display a pre-plan user-interface and a print-order user-interface which reside on the print vendor's server, the method comprising:

generating a first plan with the pre-plan user-interface on the client's computer, for example a marketing plan or marketing pre-plan for subscription offers directed to, for example, consumers of magazines, newsletters, newspaper, special interest groups, and like entities, such as in the form of a data object, by a client, for example a publisher or a third party vendor to a publisher, on a client's computer which is networked, for example, to the internet, and like networked computer systems;

exporting the resulting first plan from the client's computer to individuals within the client's organization, that is, for example, down-loading into a commercially available spreadsheet software package, such as Microsoft200 Excel, Lotus 1-2-3, or like packages or applications, and then distributing to individuals within the client's organization, such a marketing director, subscription plan manager, production department personnel, finance department personnel, accounting department personnel, strategic planning personnel, fulfillment department personnel, and like personnel;

receiving first input on the client's computer from the individuals having received and reviewed the resulting exported first plan, that is, for example, receiving input or a first level of review, for example, for technical comment, such as graphic layout, offer content, such as pricing and like terms of the offers, preliminary authorization(s) review of the first plan, and like input;

optionally revising on the client's computer the first plan based upon the received first input;

creating a first print-order on the client's computer, by:
a) importing the resulting plan into the print-order user-interface; and
b) selecting graphic elements for the print order; and

submitting the resulting first print-order to the print vendor for production via the print vendor's server.

The generation, creation, definition, or revision of one or more print orders and their detailed specifications, including “pre-plan” specifications, can be accomplished, for example, by a client such as a print-order customer, using a password protected on-line user-interface. An example of a suitable on-line user-interface is an interactive internet website which can be conveniently accessed and navigated with a browser, and which interface includes a spreadsheet having fields designated for appropriate plan specifications and plan execution information, and print-order specification information. For information and an example of the print-order system, contact or see “On-line solutions” at <www.schmidt.com>. For an example of the print-order system including a “pre-plan” component, see for example, the “User's Guide, version 3.0, www.schmidt.com” appendix of the present application, the disclosure of which is incorporated by reference herein in its entirety.

In embodiments of the present disclosure, the method can further comprise optionally selecting second input, third input, or more input from the resulting first input, that is for example, obtaining and selecting second level or greater levels of review, approval, revision, authorization, and like operations on top of, or beyond, the received or revised first input. Greater input levels from the resulting first plan or order can include, for example, procurement authorization or comment, financial projection comments, budget considerations, payment terms or options for the print order, revised terms or options for the printed offer, timing issues of submitting subsequent print orders for printing, and like inputs and considerations.

In embodiments, the first plan can be, for example, a data object. The first plan can be, for example, a marketing plan for a subscription offer and optionally the subscription offer can be represented as a data object. The subscription can be to, for example, a magazine, a newsletters, a newspaper, a special interest group communiqué, and like publications or print media.

In embodiments, “a client” can be, for example, a publisher or a third party vendor to a publisher, and which client has as an objective and incentive to be an efficient provider and manager of companion printed pieces as promotional devices. It will be readily understood that “a client” in embodiments can be one or more clients, for example, a plurality of clients, such as hundreds of clients situated around the globe. It will be readily understood that there can be more than one client within an organization. It will also be readily understood that “a client” in embodiments can be an individual or a group of individuals within an organization, or like entity, having the same shared account, or separate accounts and separate access privileges, and each account having a unique identifier. The computer network between the client and the print vendor can be, for example, a secure communications channel such as the internet or world-wide web, a local area network, a wide-area network, wireless network, or like networks. In embodiments, the print vendor's host computer can be, for example, a server, such as a internet content provider server, or like devices, capable of providing one or more user-interfaces to a remote client and capable of electronically receiving and storing the client's complete print order including layout or creative information and plan-offer information. The print vendor's plan generation user-interface preferably includes subscription plan fields, and like fields, and as illustrated herein. The computer network between the client and individuals within the client's organization can include any secure communications channel such as the internet or world-wide web, a local area network, a wide-area network, wireless network, or like networks or similar communications channels or means such as electronic mail or messaging, which channel is capable of selectively distributing “pre-plan” information within the client's organization. The computer network between the client and a server receiving and forwarding subscriber responses or summary information concerning the subscriber responses, i.e., a subscriber response server or a response clearing house server, can include and be accomplished with similar devices. The computer network between the subscriber response server and the subscribers providing offer responses can include and be accomplished with similar devices.

In embodiments, exporting can comprise down-loading the first plan from the plan generation user interface into a spreadsheet, for example, a commercially available spreadsheet software package, such as Microsoft® Excel, Lotus 1-2-3, etc., and then distributing within the organization. In embodiments, exporting can include down-loading the first plan from the plan generation user interface to a printer to produce a hard-copy. In embodiments, exporting can comprise sending the first plan to a previously specified electronic mail distribution list. In embodiments, exporting can comprise displaying the pre-plan selections on the client's computer monitor or displaying the pre-plan selections on another computer monitor within the client's organization.

In embodiments, the individuals within the client's organization can be, for example, a marketing director, a subscription plan manager, production department personnel, procurement department personnel, finance department personnel, accounting department personnel, strategic planning personnel, fulfillment department personnel, and like personnel, and combinations thereof.

In embodiments, the first input can include plan authorization, plan revision, plan comment, and like input to the plan offer, and combinations thereof. Plan revision can comprise, for example, additions, deletions, corrections, contingencies, and like revisions, and combinations thereof.

The method for pre-planning printed products can, in embodiments, further comprise:

printing the submitted first print order, for example, by the print vendor or its designee;

combining the resulting printed pieces, such as subscription offer inserts, of the first print-order with a second printed media piece, such as a magazine or a newspaper; and

distributing the combined product to consumers.

The above-mentioned steps of printing, combining, and distributing can be accomplished, for example, using conventional methods known to those skilled in the art.

The above method for pre-planning printed products can also, in embodiments, further comprise:

receiving responses to the offers contained in the printed pieces from consumers; and

modifying the plan based on the responses received by the client-user.

Modification of the plan based upon the responses received from consumers using the pre-plan component of the invention, can provide a closed information loop between marketer or its agents and consumers, and enables the system and methods of the present disclosure to provide a highly efficient iterative tool and method for creating, updating, and managing solicitation plans for companion printed pieces for use as promotional articles.

The receipt of responses to the promotional offers from consumers or subscribers can be accomplished by various means or channels, for example, self-addressed regular mail, pre-paid postage mailers, e-mail, facsimile, and preferably on-line to a designated website which website address, for example, hypothetically <www.readersmonthlymag-subscriptionoffer-oct2003.com>, appears on the companion printed piece (i.e. the offer) and which provides the identical offer information in electronic form as the offer contained in the companion printed piece. The on-line response channel is preferred in embodiments because of the potentially shorter response times to a particular specific offering and because the details of the response or summaries of the collective response can be directly or summarily electronically fed-back into a portion of the pre-plan system designated for receiving, collecting, and processing consumer response information. Thus, the system can be adapted in embodiments to provide consumers or offerees the ability to rapidly and electronically respond to particular offers made by the offeror or its agents. The system can adapted in embodiments to provide the ability for the offeror or its agents to directly receive offer response information to particular offers made to the consumer or offeree in the companion printed piece. The system also provides the ability to modify the plan based on the received offer response information.

The present disclosure provides enhancements to the efficiency and effectiveness of using companion printed pieces to promote subscription offer responses. Examples of the enhancements include: the ability of the consumers, subscribers, or offerees, to provide high speed electronic responses to offers; the ability of the companion piece originator or other affiliated vendor to process electronic responses to offers at high speed; the ability of the companion piece originator or other affiliated vendor to quickly receive input or feedback from within the organization concerning the plan generally, plan offer terms, and the plan's execution; the ability to quickly create, modify, or update the plan-offer or the resulting print-order embodying the plan; and the ability to quickly create, modify, change, or update the plan-offer in view of the consumer's or the subscriber's electronic, or otherwise, response to the offer. Examples of useful changes or modifications to the plan-offer which can be accomplished in accordance with, or in view of, the consumer's or the subscriber's response to an offer can include changing the terms of the offer, changing the number of printed offers made during an offer period, changing the geographic or demographic distributions of like offers, and like modifications.

In embodiments, the resulting plan can be, for example, the un-revised first plan, or a revised second plan. In embodiments, the export-import component comprises any known means to down-load plan information from the print vendor's server and thereafter up-load or import plan information and print order information to the print vendor's server for execution of the print order. In embodiments, the export-import component can comprise a networked computer displaying the user-interface component as illustrated herein.

A suitable means for creating and submitting a first print order is, for example, a graphical user interface, such as the “PRE-PLAN” solution including spreadsheet-like data fields and user interface data entry, and is commercially available, see <www.Schmidt.com>.

A suitable means for exporting the plan component of the first print order to individuals within the client's organization include, for example, e-mail, printed hard-copy, a physical or virtual meeting to discuss, and like media, or as illustrated herein. Similarly, suitable means for receiving input from individuals who received the plan component, include, for example, e-mail, printed hard-copy, a physical or virtual meeting to discuss, and like media, and as illustrated herein.

A suitable means for optionally revising the plan component based on the received input, that is revising the first plan or the print-order as needed, is for example, an electronic spreadsheet application product operating on a personal computer or a workstation, and accepting changes made to the information contained in the spreadsheet, such as used in the Microsoft® Exel spreadsheet's “track changes” tool.

A suitable means for importing the un-revised first plan component or the optionally revised second plan component into the user-interface to complete the first print order component for print production is by up-loading the first or revised print order information contained in the spreadsheet into the pre-plan component user-interface on the print vendor's server.

In embodiments the present disclosure provides a computer system having a graphical user interface including a display and a selection device, and a method of managing plan-order information therewith, the method comprising:

retrieving or accessing, on a first client computer, a set of menu items from the pre-plan component of a print-order user-interface on a print vendor's host computer, each of the menu items representing a subscription offer creation option;

displaying the set of menu items on the client computer;

selecting from the set of menu items;

receiving a menu entry selection signal indicative of the selection device pointing at a selected menu item from the set of menu items;

in response to the signal, exporting the selected menu items to a second client instrument, such as, an electronic mail distribution list, or individuals within the client's organization having, for example, a personal computer, a workstation, a server, an electronic mail box, or an instant electronic-messenger service, and like instruments;

receiving signals indicative of changes to the exported selected menu items on the first client computer from the second client instrument;

optionally modifying the selected menu items with received changes;

importing the resulting selected menu items or optionally modified selected menu items into the print vendor's host computer to complete a print order for printing; and

optionally storing the imported menu items on the print vendor's host computer, such as a server, for subsequent printing by the print vendor or designee, and optionally storing the imported menu items on the client's computer if desired for archival or review purposes.

In embodiments the abovementioned computer system and method of managing plan-order information therewith, can further comprise accessing on a first client computer, the imported menu items stored on the print vendor's host computer for subsequent print order-plan creation. Thus, computer system and method of the invention can provide blank templates for creating de novo print plans, and can provide previously used templates for creating subsequent print plans, whether new or continued, thereby avoiding the time and effort associated with the task of re-entering old or unchanged field information. It will be readily apparent that the abovementioned advantages of storing and retrieving print-order and plan information from the print vendor's computer can also be realized by accessing, that is, storing and retrieving print-order and plan information on the client's computer for subsequent print-order or plan creation or modification.

In embodiments the present disclosure provides a computer-readable medium having computer-executable instructions for performing a method comprising:

populating a database with values which specify a represented first print-order, the print-order including a layout component and a plan-offer component displayed on a networked computer user-interface;

exporting the plan-offer component of the populated database to a device within an organization;

receiving input concerning the exported plan-offer component from the device within the organization;

optionally revising the plan-offer component based on the received input to provide a revised second plan-offer component;

importing the un-revised plan-offer component or the optionally revised second plan-offer component into the user-interface to complete the first print-order for print production; and

optionally, following printing and distribution of the printed pieces defined by the first print-order to customers:
electronically receiving customer responses to the offer contained in the printed plan-offer component; and
revising the plan-offer component in view of the received customer responses.

In embodiments the present disclosure provides a set of application program interfaces embodied on a computer-readable medium for execution on a computer in conjunction with an application program that specifies a client's print-order to a print vendor, comprising:

a first interface that receives a client's plan-offer information; a second interface that receives a client's print layout information; and

a third interface that combines the plan-offer information and print layout information into a print order and sends the print order to a print vendor.

The first interface receives a client's plan-offer information and can also be adapted to receive input concerning the plan-offer information from individuals within the client's organization.

The abovementioned set of application program interfaces, in embodiments, can further comprise a fourth interface adapted to receive input based on offer responses from consumer or subscriber recipients of the resulting offers or printed products of the print order. The fourth interface can be adapted to provide input to the first interface.

The following definitions are used, unless otherwise described. “Client,” “client-user,” “pre-plan creator,” or “pre-plan originator” or like terms refer, for example, an individual or organization, in need of “pre-plan” services, alone or in combination with other services, such as print-order creation and print order execution, and which services are offered and provided by a print vendor through the print vendor's host server, such as a secure interactive internet website. “Plan” refers to, for example, a comprehensive collection of information relating to one or more offers in a marketing campaign. “Pre-plan” or “pre-planning” refers to a process of preparing a “plan”, such as marketing plan for the printing and distribution of printed products, ahead-of-time or in-advance of a production order or a print-order, in a compact, manageable, and portable electronic format.

“Print-order specifications” refers to all information contained in the print-order, including printed and non-printed information, and includes printing instructions, graphic layout information, and pre-plan or plan-offer information, for example, print count, paper stock, color schemes, insert types, image or text location size, and content, and like information.

“Pre-plan specifications” or “plan information” refers to all information contained in the print-order specifications, including printed and non-printed information, that relates to the pre-plan or the plan-offer, for example, “Issue,” “Product Type,” “Template,” “Version Description,” and like specifications, and as illustrated below.

“Plan generation user-interface” refers to the print vendor's networked software application which is used by the client to create and manage the “pre-plan.”

“Print-order user-interface” refers to the print vendor's networked software application which is used by the client to create and submit to the print vendor for production of the “print order.”

“Print-order” refers to a request from the client to the print vendor for printed products, such as companion printed pieces having, for example, a subscription offer or coupon offer printed thereon. The order includes layout specification information and plan-offer specification information.

“Layout specification information” refers to, for example, text, graphics, images, pre-paid postage, etc., that appears on the face of the printed piece product.

“Offer” refers to, for example, a market solicitation by an offeror, such as a vendor or provider of printed piece or published products, to an offeree, such as a potential or existing customer or subscriber for printed or published products, or services, such as a proposition for acceptance or rejection, and like attempts at establishing business relationships and transactions.

“Plan-offer specification information” refers to the terms of an offer that are to be included, for example as text in a printed offer describing the offer, and can include a wide variety of choice options to the offeree, i.e., the consumer or subscriber. Choice options in an offer can include, for example, subscription price per year, alternative subscription time periods, the number of printed issues or pieces provided in a subscription period, discount offers, multiple subscriptions, volume discounts, premium offers, alternative or companion publication offerings, alternative or companion product offerings, distribution channel(s) desired for the offered publications, products, or services, tracking codes for use in premium fulfillment, and like terms, and combinations thereof.

“Within the client's organization” refers to any work function or work activity in support of the client's business objectives and can include, for example, any operation inside or external to the client's physical location, such as a an adjacent or remote location. “Individuals” can include, for example, regular full- or part-employees, suppliers, vendors, customers, contractors, consultants, and like personnel, situated in a variety of locations. A remote location can be any single or plural physical location other than where the print plan is generated, such as where the print plan and print order is reviewed, evaluated, revised, and like modifications, for example, in an office situated next to or within the client's office where the client's networked computer resides, a communicatively linked network of offices situated in other cities, counties, states, or continents, and combinations thereof. The “client's organization” can include, for example, any traditional business organization, such as corporations, partnerships, joint ventures, non-profits, and like organizations, but can also include other business associations or enterprises having any common interests, such as client-material supplier, client-service provider, client-consultant, manager-employee, director-associate, and like relationships. The client's discretion in selecting distribution personnel can include instances where the resulting down-loaded first plan is not electronically or physically distributed within the client's organization, but instead the distribution can be accomplished by, for example, observation, for example, where one or more individuals view the down-loaded plan on the client's computer monitor.

“Exporting” refers to and can include distributing the resulting down-loaded first plan to individuals within the client's organization and can be at the client's discretion, selection, or otherwise, and the client can optionally select or designate a distribution list or preferred distribution list of recipients, for example, a hard copy or e-mail distribution list. The first plan or subsequent plans can be distributed to responsible parties within the organization on a need-to-know or need-to-act basis, such as to individuals who are related to, or involved in the print plan and print order work flow process and any aspect of its creation, fulfillment, or use of the resulting print job, such as designers, marketers, sales persons, managers, decision makers, officers, corporate identity department, legal department personnel, and like individuals. Distribution can be accomplished, for example, electronically such as by e-mail, an e-mail attachment, and like networked methods. Distribution can also be accomplished, for example, physically, such as by printing the down-loaded first plan and circulating in hard-copy form.

“Input” from the selected individuals having received and reviewed the resulting exported first plan can include, for example, suggested or requested changes, such as, additions, deletions, rearrangement, reconfiguration, recolor, touch-up, and like revision of viewable image elements (e.g. text, line art, photo-images, etc.) “Input” can also include individual or group contributions, for example, approvals, such procurement approval, disapprovals, validations, comments, suggestions, proposals, and like contributions. In embodiments, approval “input” can be structured hierarchically to include, for example, a decision tree or hierarchy, such as, an all-or-none approval scheme, a majority (simple, super, plurality, etc.) approval scheme, and like decision-making procedures.”

Consumers” or “customers” refers in embodiments to, for example, current subscribers, prospective subscribers, single point-of-purchase buyers such as from a newsstand, grocery isle, and like channels, publication brokers, gratuitous readers such those having access to trial issues, free copies, or subscriptions paid for by another, such as from the publisher, a library, a neighbor, and the like sources, and fulfillment houses, such as those receiving a response from a consumer to redeem a premium offer or coupon, or combinations thereof.

“Responses” refers in embodiments to, for example, acceptance of the terms and conditions of one or more offers by a consumer, rejection of the offered terms by a consumer, rejection of the offered terms but an expressed interest in future offers by a consumer, election of a premium option by a consumer, and like answers selected from those that may be available options contained in the offer.

A “spreadsheet” refers to graphical representation, such as on a sheet of paper or on a computer display, which shows accounting or other data in rows and columns. “Spreadsheet” also refers to a computer application program that simulates a physical spreadsheet by capturing, displaying, and manipulating data arranged in rows and columns. In a spreadsheet, spaces that hold items of data are called cells. Each cell is labeled according to its placement (for example, A1, A2, A3 . . . ) and may have an absolute or relative reference to the cells around it. A spreadsheet is generally designed to hold numerical data and short text strings. Spreadsheets usually provide the ability to portray data relationships graphically. Spreadsheets generally do not offer the ability to structure and label data items as fully as a database and usually do not offer the ability to query the database. In general, a spreadsheet is a simpler program than a database program.

A “database” refers to a collection of data that is organized so that its contents can easily be accessed, managed, and updated, for example: a relational database, which is a tabular database in which data is defined so that it can be reorganized and accessed in a number of different ways; a distributed database which can be dispersed or replicated among different points in a network; or an object-oriented programming database which can be congruent with the data defined in object classes and subclasses. The databases can contain aggregations of data records or files, such as sales transactions, product catalogs and inventories, and customer profiles. In embodiments, the client-user or the print vendor can act as a database manager, for example, controlling users read/write access, specifying report generation, and analyzing usage. Database products are commercially available, for example, IBM's DB2, Microsoft's Access, and database products from Oracle, Sybase, and Computer Associates.

In embodiments the “pre-plan” component of the user interface can be an electronic spreadsheet. In embodiments the “pre-plan” component of the user interface can be a database, for example, in more complex and informational intensive applications, such as incorporating subscriber or consumer response information or summaries thereof.

The following is one set of many possible examples of “Pre-Plan” Data Entry Fields that can be used in the “pre-plan” component user-interface, their definitions, and representative examples where applicable.

“Issue” which is the date of a publication, usually the month and year, for example, December, 2003.

“Product Type” is the product types available for order on-line, for example, buckslips, brochures, blow-ins, bind-ins, cover wrap, outserts, self-mailers, letters, and like product types.

“Template” refers to an online customizable creative, such as art work.

“Version Description” refers to a description used to uniquely identify the final printed product.

“Version Group” identifies the versions that are grouped for print efficiencies.

“A/B Split” refers to mixing versions for test marketing or other purposes.

“Split With” identifies the version a split is mixed with.

“Code” refers to a specific series of numbers and/or letters used on jobs to track printed items.

“Quantity” refers to the number to prints of a particular version, for example, a 100,000 piece order has a quantity of 100,000.

“Arrival Date/Due” refers to the date the printed product pieces are due at the printer or bindery.

“Ship To” refers to the address the printed product pieces shall be shipped to.

“Ship Attention” refers to the contact person(s) at the Ship-To address.

“Special Instructions (Shipping)” refer to any special requests or exceptions to the standard operating procedure(s).

In embodiments, the plan fields can be readily expanded, customized, or easily modified to provide, for example, additional or revised customer specific plan fields or customized plan fields as illustrated by the following examples.

“Region” refers to a geological area, for example, South Atlantic (USA).

“Version Type” identifies the offer advertised, i.e. control or test.

“BRC URL” refers to a specific web address which can be used to track responses for the advertised offer.

“Web site equivalent offer ” refers to a world wide web address or equivalent network accessible address which when accessed provides at least the equivalent offer content as contained in the companion printed piece offer. A consumer or subscriber accessing the site can select options and respond to the offer by transmitting an electronic form or image which contains their response choices, payment method, desired delivery address, mailing- or billing-address, and other information.

“Term Value” refers to the length and rate of the advertised offer, for example, a 12 month subscription at $11.97.

“Savings” refers to the off-saving or percentage difference between the subscription price offer and the news stand price for the equivalent term.

“Card Type” identifies the type of publication the offer piece or printed card bearing the offer is inserted in or bound to, for example a newsstand or subscription.

“Effort Key” refers to a specific series of numbers and/or letters used on print jobs to track printed pieces.

“Card 800#” refers to a toll-free phone number a consumer or subscriber can use to respond to an advertised offer.

“Art Job #” refers to a specific series of numbers and/or letters used to identify a creative.

“Term” refers to the length of time the offer is advertised, for example, 12 months.

“Rate” refers to the cost of the advertised offer, for example, $19.97.

“Premium” refers to, for example, a free gift or special advertised offer, for example, a free gear bag with a subscription order.

“Premium Code” refers to a specific series of numbers and/or letters used to identify a premium.

“PO Box” refers to, for example, the post office box of a fulfillment house, such as a vendor which receives fulfillment orders and provides fulfillment premiums to subscribers or consumers.

“Zip+4” refers to the full zip code of the fulfillment house.

The indefinite article “a” or “an” and its corresponding definite article “the” as used herein is understood to mean at least one, or one or more, unless specified otherwise.

Centralized print production systems that can accept print orders over communications networks and allow a print customer to approve on-screen print proofs are known, see for example, U.S. Pat. Nos. 6,167,382, and 6,535,294. Methods and systems for determining and applying discounts using point-of-sale information are known, see for example, U.S. Pat. Nos. 6,415,262 and 5,970,470. Methods and systems for sharing messages, data objects, or resources are known, see for example, U.S. Pat. Nos. 5,913,032, and 6,324,587.

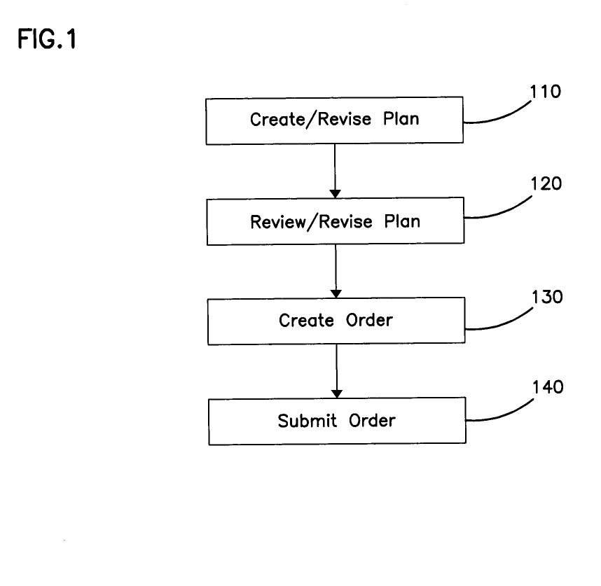

Referring to the Figures, FIG. 1 illustrates a summary flow chart of the system and method in embodiments of the present disclosure. Create/Revise Plan 110, provides for the “pre-plan” being created and the resulting preliminary plan is optionally revised by a client using a first interface networked to the print vendor's host computer. Review/Revise Plan 120, provides for review and comment, and optionally revision, and like input by individuals within the client's organization, concerning the

“pre-plan” following distribution to the individuals. The Review/Revise Plan 120 can be accomplished, for example, off-line or using an intra-net system. Create Order 130, provides for the client to create the print order using the networked user-interface, such as a third interface. First, the client receives the input concerning the “pre-plan” from one or more individuals within the organization, using the first interface. The client optionally factors or weighs the input, subjectively or objectively, and includes some, all, or none of the input into the “pre-plan” component of the print order, depending on, for example, predetermined factoring, weighting, and like selection criteria which can be particular to, or a preference of the client or the client's organization. Next the client specifies the layout information component of the print order, using for example a second interface. The “pre-plan” component is then merged with the layout information component to complete the print order, using for example a third interface. Submit Order 140, provides for the client to submit or send the completed print-order request to the print vendor's networked server for execution, using for example the third interface.

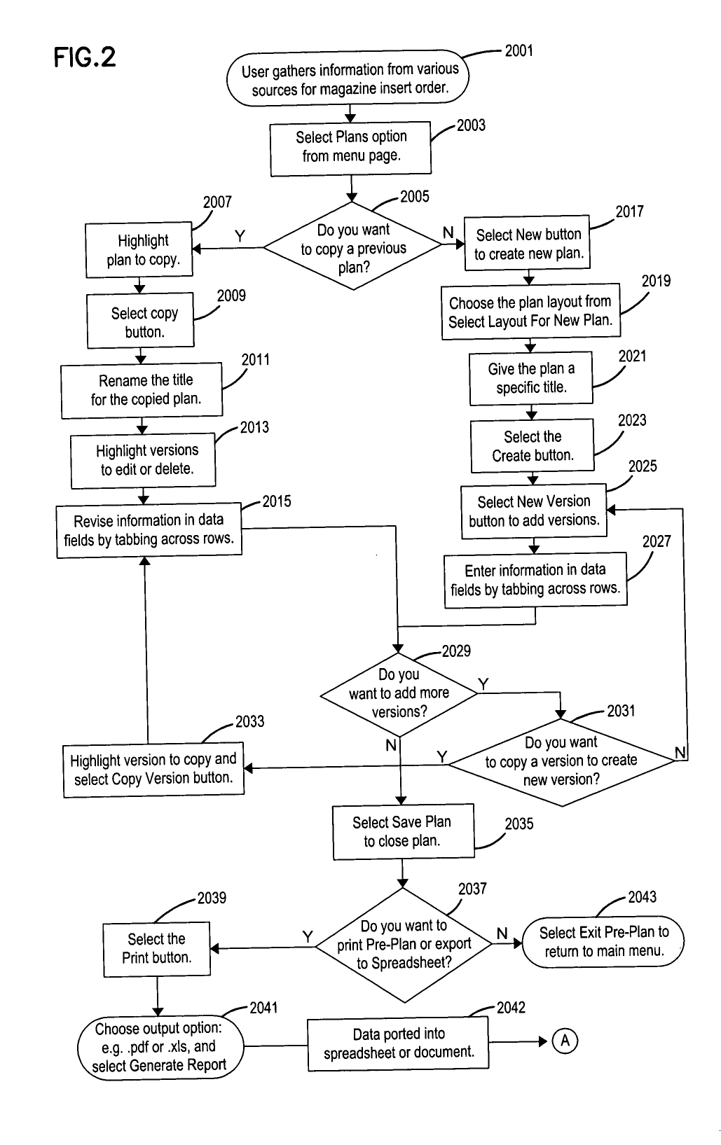

FIG. 2 illustrates a flow chart for creation of the “pre-plan” or plan-offer component in embodiments of the present disclosure. A client or user gathers information from various sources for plan and specific offers, for example, a single or multi-issue magazine insert order 2001. The client-user selects “Select Plans” option from a menu page 2003. The client-user decides whether to “copy a previous plan?” 2005. If the client-user decides yes, client-user highlight(s) the plan to copy 2007 to reuse a previous plan, and selects “Copy” button 2009 to load a previous plan into the “pre-plan” first interface. The client-user creates a unique identifier name to rename the title for the copied plan 2011, and can thereafter highlight selected versions to edit or delete 2013, and revise information in data fields by tabbing across rows 2015. If the client-user decides “no” to “copy a previous plan?” 2005, the client-user selects the “New” button to create new plan 2017. The client-user chooses a plan layout from “Select Layout For New Plan” 2019 and gives the plan a specific title 2021. The client-user then selects the “Create” button 2023 and selects the “New Version” button 2025 to add versions. The client-user thereafter enters the information in the appropriate data fields by tabbing across rows 2027. The “pre-plan” user interface then asks the client-user to decide whether to “add more versions?” 2029. A “yes” response to 2029 prompts whether to “copy a version to create new versions?” 2031. A “yes” response to 2031 prompts the client-user to highlight the version to copy and select the “Copy Version” button 2033 and a return to revise information in fields by tabbing 2015. A “no” response to 2029 causes the client-user to select “Save Plan” to close plan 2035. A “no” response to 2031 prompts the client-user to return to select “New Version” 2025. The client-user then decides whether to “print” the Pre-plan or “export to spreadsheet?” 2037. A “yes” response to 2037 prompts the client-user to select the “Print” button 2039, and thereafter to choose an output option, such as a portable document format (e.g., .pdf), and spreadsheet format (e.g., xls), or like options, and thereafter to select “Generate Report” 2041, for example, for export within the client's organization or for merger as “un-revised” with the layout information into the “print-order” interface. The “pre-plan” output data resulting from “Generate Report” 2041 is ported into a spreadsheet or document 2042, and comprises the preliminary pre-plan or first pre-plan (A). A “no” response to 2037 prompts the client-user to select “Exit Pre-Plan” 2043 to return to the main menu.

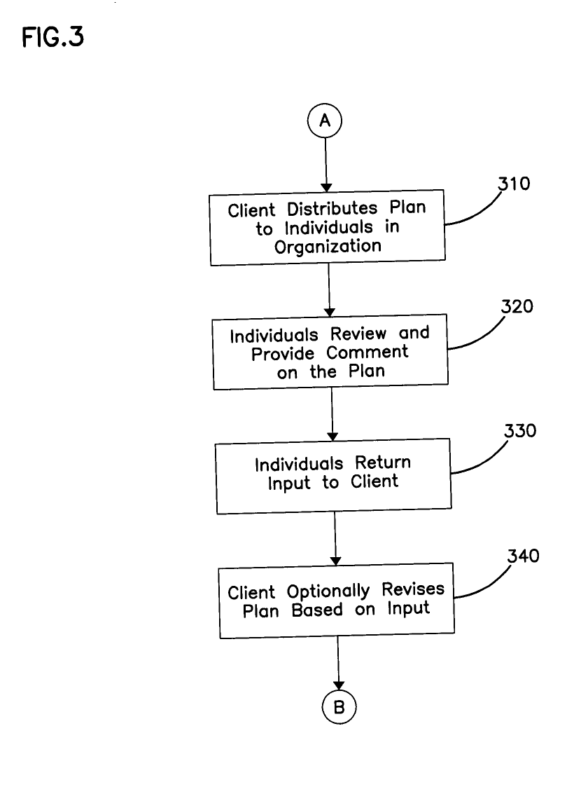

FIG. 3 illustrates a flow chart representing the review and revision phase of the exported “pre-plan” component (A) by individuals or internal clients within the client's organization. First, the client exports or distributes the “pre-plan” component (A) to individuals within organization 310. The individuals review and optionally provide comments, revisions, and like input 320, concerning the pre-plan. The individuals return input to client-user or “pre-plan” creator or originator 330. Next, the client-user optionally revises the “pre-plan” to a revised plan (B) based on the received input 340. The resulting revised plan (B) output can be merged “as revised” with the layout information into the “print-order” interface.

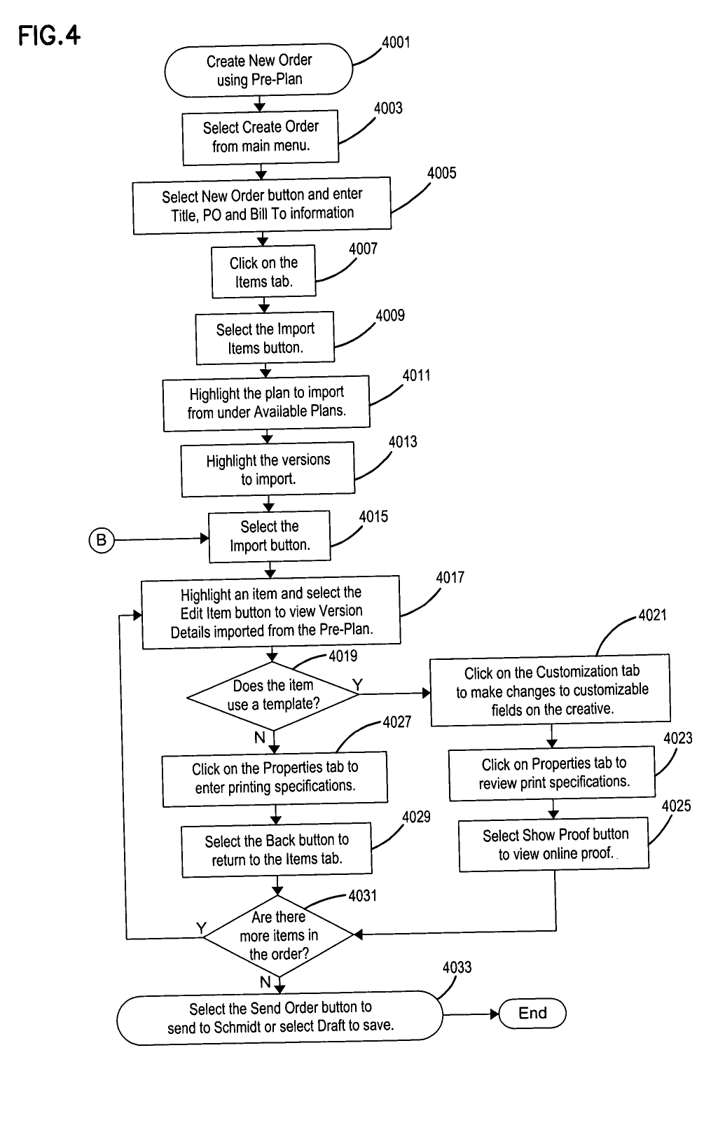

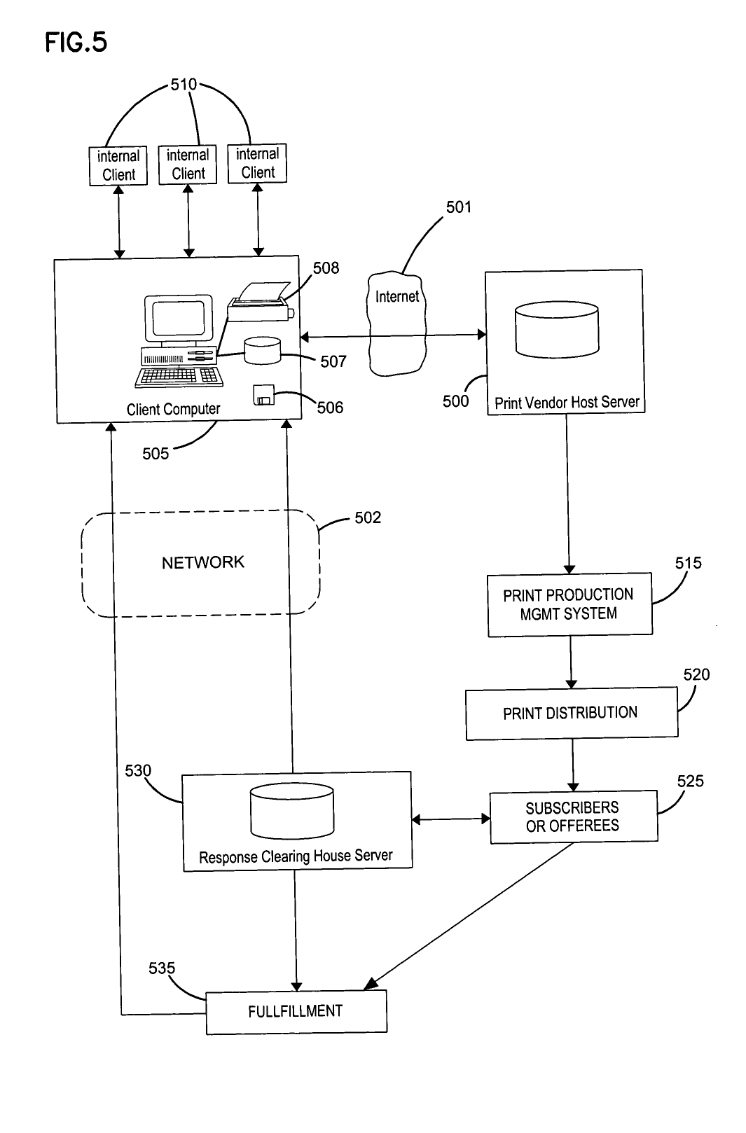

FIG. 4 illustrates a flow chart representing the creation of the print order component in embodiments of the present disclosure. The client-user creates or originates a new print-order which will incorporate “pre-plan” information by accessing the print-order interface 4001. The client-user selects “Create Order” 4003 from the main menu, and then selects “New Order” button 4005 and enters Title, purchase order (PO), and Bill To information into those labeled fields. Next, the client-user clicks on the “Items” tab 4007 and selects the “Import Items” button 4009 which calls up previous plan information from the host server, if any, to avoid unnecessary repeat data entry. The client-user highlights the plan or plans to import from under the “Available Plans” section 4011 of the print-order items interface, and highlights the desired versions of available plans to import 4013 into the items interface. The client-user selects the “Import” button 4015 to bring the selected plan(s) and version(s) into the interface, for example, the above mentioned un-revised pre-plan or as the revised pre-plan (B). The client-user then highlights the imported item(s) and selects the “Edit Item” button 4017 to view “Version Details” from the imported pre-plan. The client-user then decides whether the “item uses a template?” 4019. If “yes”, then the client-user clicks on the “Customization” tab 4021 to make changes to customizable fields on the creative, that is layout information component of the print order, and thereafter clicks on “Properties” tab 4023 to review the print specifications associated with the creative. In the final step of the 4019 “yes” manifold, the client-user selects “Show Proof” button 4025 to view an on-line proof or electronic image representing both sides of the fully composed printed piece and the object of the print-order for inspection of both layout component information and printed plan-component information. It is readily understood that not all plan information appears in the viewable electronic proof, such as number of pieces to be printed. However, the unprinted plan information remains with the electronic print-order when submitted to the print vendor. If the client-user decides “no” in the 4019 manifold, then the client-user clicks on the “Properties” tab 4027 to enter particular printing specifications, and thereafter selects the “Back” button to return to the “Items” tab 4029. The client-user then decides whether “are there more items in the order?” 4031. If there are more items in the order (“yes”) the client-user returns to and highlights additional imported item(s) and selects the “Edit Item” button 4017 to view “Version Details” from additional the imported pre-plan information. If there are no more items in the order (“no”) the client-user selects the “Send Order” button 4033 to send the completed print-order to the print vendor's server, such as Schmidt.com, or alternatively, the client-user selects “Save Order and Exit” button to save the draft print-order for further changes prior to sending. The completed and sent print-order output (END) is received and processed by the print vendor.

FIG. 5 illustrates a functional diagram of the system and method in embodiments of the present disclosure. A print vendor's host computer 500, such as a networked server having internet access 501, provides the print-order and its other component interfaces for display on a networked client computer 505. The client computer is preferably adapted with, for example, portable storage media 506, such as a floppy disk, compact disc, DVD, or like suitable portable storage media, an internal server 507, for example, an intranet, a hard disk drive, internal mail server, or other suitable storage media and communications means, a printer 508, or like devices, for producing hard copy of resulting draft or final pre-plan and print-order documents. The portable media 506, the server 507, or the printer 508, can be used to document draft pre-plan information or print-order information, and to distribute to, and receive responses from, individuals within the client's organization, such as internal clients 510.

When the print vendor receives a print-order from a client, the order is processed by, for example, a print production management system 515, which receives the order and executes the print job in accordance with the client's specifications. The resulting printed pieces of the print job are distributed 520 as specified by the client, for example, to a magazine publisher's or printer's finishing facility for packaging or combination with other printed media and made available to consumers in accordance with the client's plan. The finished print product, which includes the printed piece(s) bearing the offer(s), is received and considered by consumers, such as subscribers or offerees 525. The subscribers or offerees can respond to the printed offers, for example, a designated offer response clearing house 530 by, for example, regular pre-paid mail associated with the printed offer, or by accessing the designated website and web address, such as on the internet 503 (not shown), which offer is printed on the face of the offer and which site provides an interface which presents the consumer with an on-line offer that is identical to the printed offer. The response clearing house 530 receives the consumer's offer responses and can forward response information on the internet 503 (not shown), to, for example, a fulfillment house 535 which can initiate subscription or premium fulfillment obligations, or additionally or alternatively, provide the response information to the client 505 for use in assessing current and future marketing campaigns and in designing or modifying current or future “pre-plans.” Similarly, the fulfillment house 535 can feed-back or report out actual fulfillment information and results to the client, for example, the number and type of offers fulfilled, the type of premiums filled reflecting consumer demand, and like data, on a timely basis, such as daily, monthly, annually. Feed-back or report-out information from the clearing house 530 or fulfillment 535 is preferably accomplished over a network 502 connected to the client's computer, such as a intranet server 507 or equivalent alternative communication means. The subscriber may optionally respond to the fulfillment house over the internet 503 (not shown).

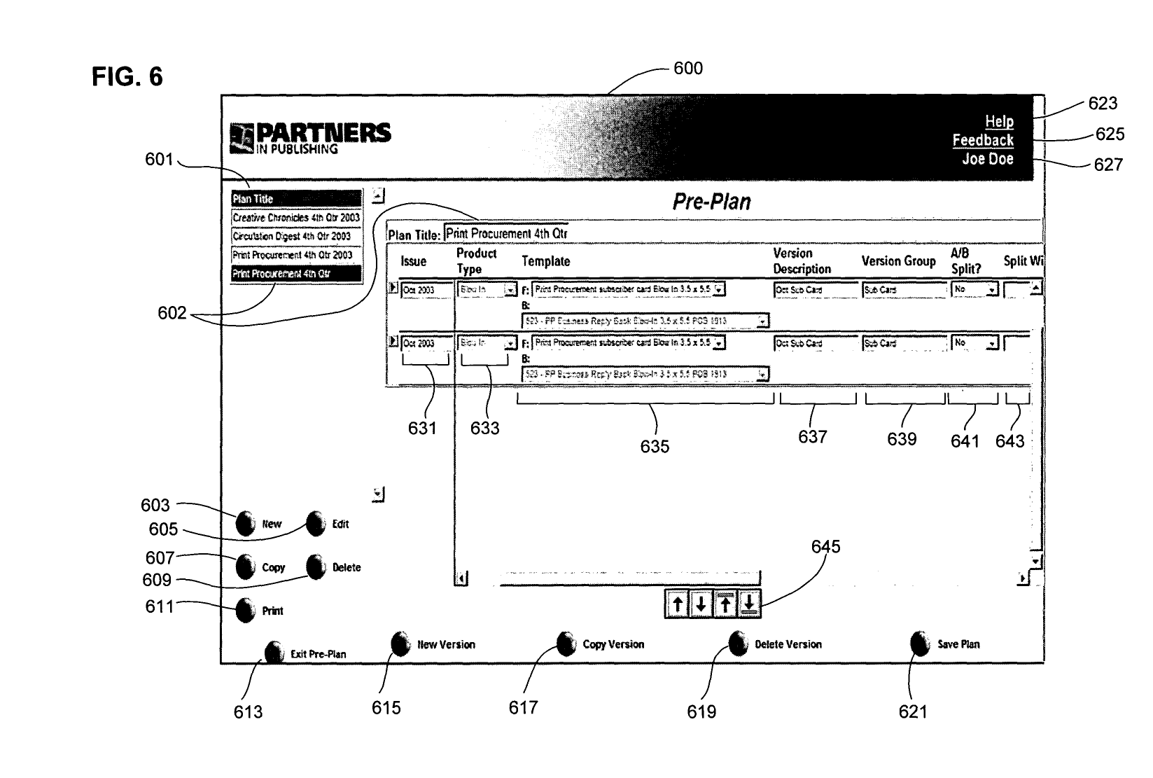

FIG. 6 is an exemplary “pre-plan” creation screen 600 showing many of the structural features described above for FIG. 2, for example, Plan Title field 601, a highlighted plan title and its appearance in the Plan Title field 602, New button 603, Edit button 605, Copy button 607, Delete button 609, Print button 611, Exit Pre-Plan button 613, New Version button 615, Copy Version button 617, Delete Version button 619, Save Plan button 621, Issue field 631, Product Type field 633, Template field 635, Version Description field 637, Version Group field 639, A/B Split? field 641, Split With field 643, and like fields accessed by lateral scrolling, HELP support link 623 including on-line User's Guide documentation and instructions, Feedback link 625, client-user name 627 and reposition tool 645.

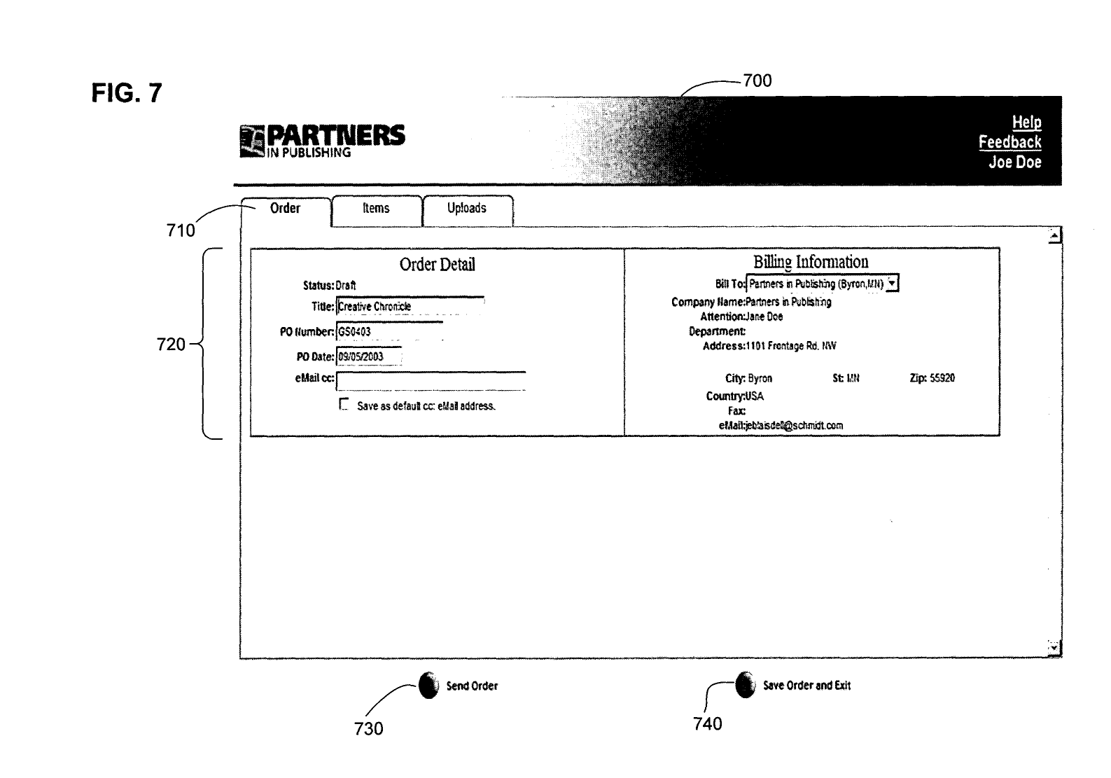

FIG. 7 illustrates an exemplary print-order component creation screen 700 showing many of the structural features described above for FIG. 4, for example, Order tab 710, Order Detail and Billing Information fields 720, Send Order button 730, and Save Order and Exit button 740.

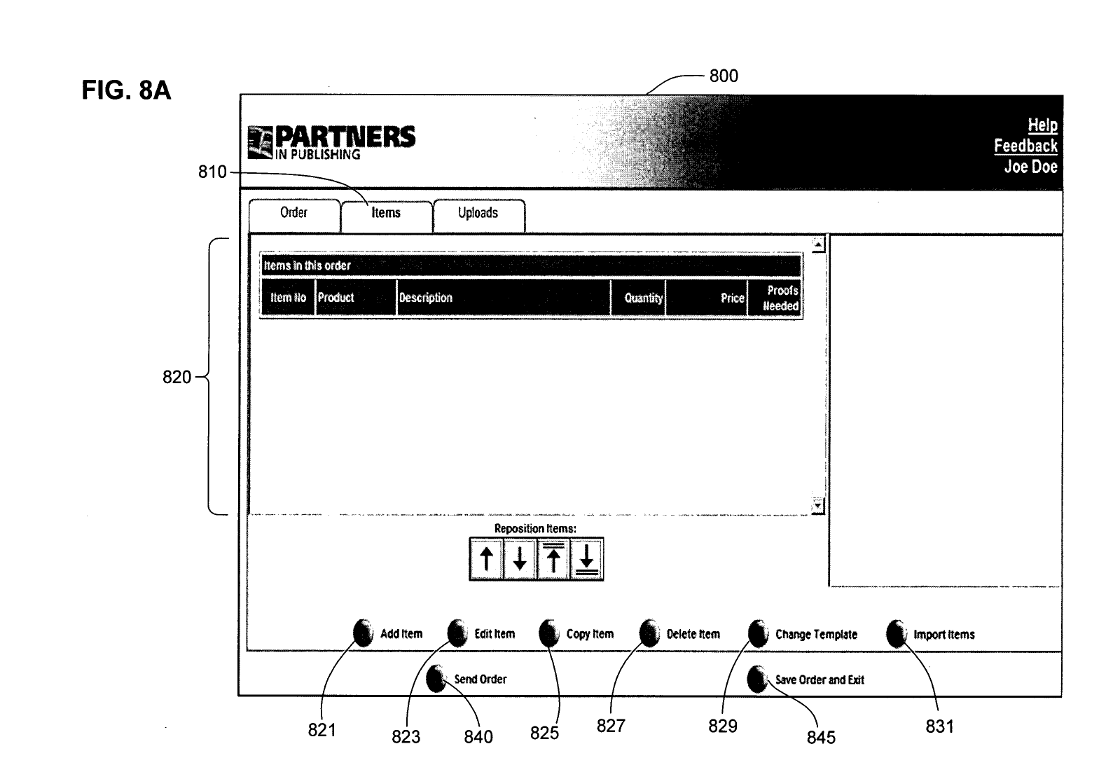

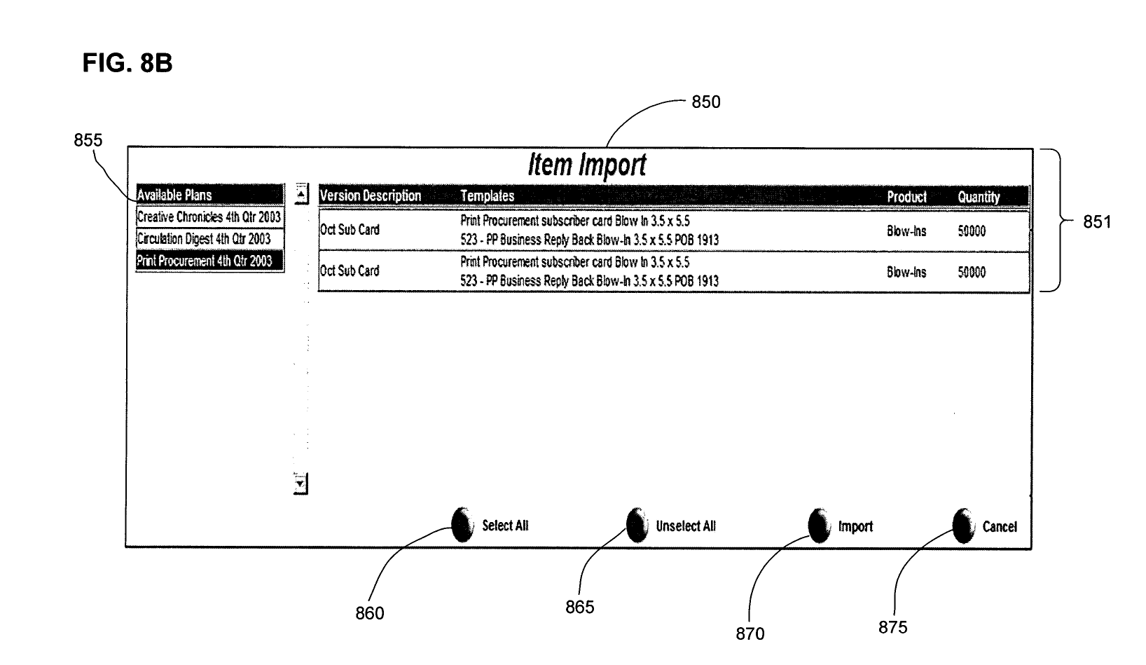

FIG. 8A illustrates another exemplary print-order component creation screen 800 showing, for example, Items tab 801, Item specification fields 820, Add Item button 821, Edit Item button 823, Copy Item button 825, Delete Item button 827, Change Template button 829, Import Items button 831, Send Order button 840, and Save Order and Exit button 845.

FIG. 8B illustrates the merger aspect of the print-order component creation screen of FIG. 8A showing, for example, the result of selecting the Import Items button 831. Selecting 831 causes the Pre-Plan component output (B), mentioned in FIG. 3 and FIG. 4, to be displayed. The Item Import screen 850 includes pre-plan specifications fields 851, Available Plans display 855, Select All button 860, Unselect All button 865, Import button 870, and Cancel button 875. Selecting Cancel button 875 imports or merges the Item Import information into the print-order component interface 800 of FIG. 8A.

The following serve to more fully describe the manner of using the above-described invention, as well as to set forth the best modes contemplated for carrying out various aspects of the invention. It is understood that these examples in no way serve to limit the true scope of this invention, but rather are presented for illustrative purposes.

### EXAMPLE 1

In one embodiment, the computing system can be used by, for example, a printing industry company, an advertising industry company, a merchandizing industry company, a promotional industry company, and like industry companies which create and manage printed pieces, such as companion printed pieces, for its own use or sales, or for the use or sales by another entity in a marketing channel or distribution chain. The industry client creates or develops a marketing plan using the computing system and method of the invention, which plan is adaptable for inclusion into the pre-plan component or plan-offer component using the plan creation user-interface. The marketing plan can be based upon various business considerations and like considerations, such as market penetration, market saturation, market timing, projected market demand, economic forecasts, industry trends, and like considerations. The resulting pre-plan component or plan-offer component specifies, for example, one or more subscription offers that will appear on the face of the printed pieces distributed to consumers. The resulting pre-plan component or plan-offer component is distributed or exported, preferably electronically, within the client-user's organization for comment and proposed revisions for the purpose of refining relevant aspects of the plan-offer in view of, for example, technical, legal, administrative, finance, and like departmental personnel inputs. The resulting pre-plan component can be revised by client-user's, in-part or in-total, in view of input received from interested parties within the client-user's organization, for example, at the client-user's discretion or based on other predetermined organizational criteria. The original resulting pre-plan or the resulting revised pre-plan component is combined with other components of the print-order such as the layout or graphic image information to form the complete electronic print-order. The complete electronic print-order can be, if desired, revised further or it can be submitted for print production. The resulting pre-plan component or plan-offer component can be stored for subsequent reuse or modification in future plans. The complete electronic print-order is electronically submitted to the print vendor for printing, for example, using a print-order submission interface. The print-order is produced and distributed to consumers as, for example, printed pieces containing, for example, subscription offer information contained in the pre-plan. The consumers can respond to the offers by, for example, regular mail using the printed piece as a mailer or on-line to dedicated web site address, such as a response clearing house or a fulfillment house, featuring the self-same electronic offer as was contained in the printed piece offer. The client-user can, if desired, receive response information, such as a tabulation of all response information during a response period, cumulative or rolling response information, or statistical summaries of the response information, from the response clearing house or the fulfillment house. The consumer response feed-back obtained from the response clearing house or the fulfillment house can be fed-back into the pre-plan component to create or modify current or future plan-offers and print-order. The resulting plan-offers and print-orders having the benefit of the consumer response information can better reflect market demand and likely market trends.

All publications, patents, and patent documents are incorporated by reference herein in their entirety, as though individually incorporated by reference. The invention has been described with reference to various specific and preferred embodiments and techniques. However, it should be understood that many variations and modifications can be made while remaining within the spirit and scope of the invention.

1. A method for pre-planning printed products between a print vendor's server and a client's computer networked to the print vendor's server, the client's computer being adapted to display a pre-plan user-interface and a print-order user-interface which reside on the print vendor's server, the method comprising:
generating a first plan with the pre-plan user-interface on the client's computer;
exporting the resulting first plan from the client's computer to individuals within the client's organization;
receiving first input on the client's computer from the individuals having received and reviewed the resulting exported first plan;
optionally revising on the client's computer the first plan based upon the received first input;
creating a first print-order on the client's computer, by:
a) importing the resulting plan into the print-order user-interface; and
b) selecting graphic elements for the print order; and
submitting the resulting first print-order to the print vendor for production via the print vendor's server.

2. The method of claim 1 wherein the first plan is a data object.

3. The method of claim 1 wherein the first plan is a marketing plan for a subscription offer.

4. The method of claim 3 wherein the subscription offer is to a magazine, a newsletters, a newspaper, a special interest group, or combinations thereof.

5. The method of claim 1 wherein the client's organization is a publisher or a third party vendor to a publisher.

6. The method of claim 1 wherein the computer network comprises the internet, a local area network, or a wide-area network.

7. The method of claim 1 wherein the print vendor's server includes a workstation, mini-computer, or main-frame host computer.

8. The method of claim 1 wherein the pre-plan user-interface includes subscription plan fields.

9. The method of claim 1 wherein exporting comprises down-loading the resulting first plan from the pre-plan user-interface into a spreadsheet.

10. The method of claim 1 wherein exporting comprises printing the resulting first plan from the pre-plan user-interface.

11. The method of claim 1 wherein importing the resulting plan is the resulting first plan or else the resulting optionally revised second plan.

12. The method of claim 1 wherein selecting graphic elements for the print order is accomplished by choosing menu items provided by the print-order user-interface, by a client-user providing customized graphic elements, or combinations thereof.

13. The method of claim 1 wherein individuals within the client's organization comprise a marketing director, a subscription plan manager, production department personnel, procurement department personnel, finance department personnel, accounting department personnel, strategic planning personnel, fulfillment department personnel, and combinations thereof.

14. The method of claim 1 wherein the first input includes plan authorization, plan revision, plan comment, and combinations thereof.

15. The method of claim 14 wherein plan revision comprises additions, deletions, corrections, contingencies, and combinations thereof.

16. The method of claim 1 further comprising:
printing the submitted first print-order;
optionally combining the resulting printed pieces of the first print-order with a second printed piece;
distributing the resulting printed pieces or the resulting combined pieces to consumers;
receiving responses to the offers in the resulting printed pieces from consumers; and
modifying the plan based on the responses.

17. The method of claim 16 wherein consumers comprises current subscribers, prospective subscribers, single point-of-purchase buyers, gratuitous readers, fulfillment houses, or combinations thereof.

18. A pre-plan system for managing printed information of printed products between a print vendor's server and a client's computer networked to the print vendor's server, the client's computer being adapted to display a user-interface which interface resides on the print vendor's server, the system comprising:
1) a print-order component operative to:
a) create;
b) optionally revise; and
c) submit,
a print-order by the client to the print vendor for printing, the print-order component having a layout information user-interface and plan-offer information user-interface; and
2) an export-import component operative to:
a) export a first plan-offer from the plan-offer information user-interface to individuals within the client's organization;
b) receive input from the individuals having received and responded to the exported first plan-offer;
c) optionally revise the first plan-offer in view of the received input; and
d) import the resulting plan-offer into the print-order component to complete the print order prior to submitting for printing.

19. The pre-plan system of claim 18 wherein the resulting plan is the un-revised first plan.

20. The pre-plan system of claim 18 wherein the resulting plan is a revised second plan.

21. The pre-plan system of claim 18 wherein the export-import component comprises a spreadsheet adapted to receive down-loaded plan information from the plan-offer information user-interface and to provide up-loaded plan information to the plan-offer information user-interface.

22. The pre-plan system of claim 18 wherein the export-import component comprises the client's computer displaying the plan-offer information in a spreadsheet format separated from of the plan-offer information user-interface.

23. A pre-planning system for managing and marketing printed products, between a print vendor's server and a client's computer networked to the print vendor's server, the client's computer being adapted to display a user-interface over the print vendor's server, the system comprising:
means for creating and submitting a first print-order by the client, the print-order including a layout component and an plan component;
means for exporting the plan component of the first print-order to individuals within the client's organization;
means for receiving input from individuals having received the exported plan component;
means for optionally revising the plan component based on the received input; and
means for importing the un-revised first plan component or else the optionally revised second plan component into the first print-order to complete the order for production.

24. The pre-planning system of claim 23 wherein the means for creating and submitting the first print-order is a print-order user-interface.

25. The pre-planning system of claim 23 wherein the means for exporting the plan component of the first print-order to individuals within the client's organization is an electronic spreadsheet displayed on the client's computer.

26. The pre-planning system of claim 23 wherein the means for receiving input from individuals having received the exported plan component is an electronic spreadsheet displayed on the client's computer.

27. The pre-planning system of claim 23 wherein the means for importing the un-revised first plan component into the first print-order ignores any changes to an electronic spreadsheet containing the first plan.

28. The pre-planning system of claim 23 wherein the means for importing the revised second plan component into the first print-order accepts any changes to an electronic spreadsheet containing the revised second plan.

29. A method for pre-planning printed products on a remote computing platform networked to a server computing environment, the remote computing platform being adapted to display a pre-plan user-interface and a print-order user-interface available from the server computing environment, the method comprising:
generating a first plan on the pre-plan user-interface;
exporting the resulting first plan within the remote computing platform's organization;
receiving first input on the resulting exported first plan from within the organization on the remote computing platform;
optionally revising the first plan to provide a revised second plan based upon the received first input on the remote computing platform;
creating a first print-order on the print-order user interface by:
a) importing the resulting first plan or the optionally revised second plan; and
b) selecting graphic elements for the print order; and
submitting the resulting first print order to the server computing environment.

30. The method of claim 29 wherein the remote computing platform is further adapted to display the resulting pre-plan in a third user-interface.

31. The method of claim 30 wherein the third user-interface is an electronic spreadsheet.

32. The method of claim 30 wherein the third user-interface is an electronic database.

33. The method of claim 29 wherein the remote computing platform is a client's computer.

34. The method of claim 29 wherein the server computing environment is a print-vendor's host computer.

35. In a computer system having a graphical user interface including a display and a selection device, a method of managing plan-order information, the method comprising:
retrieving, on a first client computer, a set of menu items from the pre-plan component of a print-order user-interface on a print vendor's host computer, each of the menu items representing a subscription offer creation option;
displaying the set of menu items on the first client computer;
receiving a menu entry selection signal indicative of the selection device pointing at a selected menu item from the set of menu items;
in response to the signal, exporting the selected menu items to a second client instrument;
receiving signals indicative of changes to the exported selected menu items on the first client computer from the second client instrument;
optionally modifying the selected menu items with received changes;
importing the resulting selected menu items or optionally modified selected menu items into a print vendor's server to complete the plan-offer component of a print-order for printing; and
storing the imported menu items on the print vendor's server for subsequent printing.

36. The method of claim 35 further comprising accessing, on the first client computer, the imported menu items stored on the print vendor's server for print-order creation.

37. The method of claim 35 further comprising accessing, on the first client computer, the imported menu items stored on the print vendor's server for modification of the print-order or modification of the plan-offer.

38. A computer-readable medium having computer-executable instructions for performing a method comprising:
populating a database with values which specify a represented first print-order, the print-order including a layout component and a plan-offer component displayed on a networked computer user-interface;
exporting the plan-offer component of the populated database to a device within an organization;
receiving input concerning the exported plan-offer component from the device within the organization;
optionally revising the plan-offer component based on the received input to provide a revised second plan-offer component;
importing the un-revised plan-offer component or the optionally revised second plan-offer component into the user-interface to complete the first print-order for print production; and
optionally, following printing and distribution of the printed pieces defined by the first print-order to customers:
electronically receiving customer responses to the offer contained in the printed plan-offer component; and
revising the plan-offer component in view of the received customer responses.

39. The computer-readable medium of claim 38 wherein populating the database is accomplished automatically with values specified by a computer user.

40. A set of application program interfaces embodied on a computer-readable medium for execution on a computer in conjunction with an application program that specifies a client's print order to a print vendor, comprising:
a first interface that receives a client's plan-offer information;
a second interface that receives a client's layout print information; and
a third interface that combines the plan-offer information and layout print information into a print-order and electronically transmits the print-order to a print vendor for printing the print-order.

41. The set of application program interfaces of claim 40 wherein the first interface receives input concerning the plan-offer information from individuals within the client's organization.

42. The set of application program interfaces of claim 40 further comprising a fourth interface that receives input based on offer responses from consumer recipients of the resulting printed print-order.

43. The set of application program interfaces of claim 40 wherein the fourth interface provides input to the first interface.
